(19) United States
(12) Patent Application Publication
(10) Pub. No.: US 2013/0146032 A1
(43) Pub. Date: Jun. 13, 2013

(54) Oil-Electricity Separation Type Diesel Heater

(71) Applicants: Shuishan Zhou, Hebei (CN); Haibo Jiang, Hebei (CN); Ling Zhao, Hebei (CN); Lichuan Shen, Hebei (CN); Liling Feng, Hebei (CN)

(72) Inventors: Shuishan Zhou, Hebei (CN); Haibo Jiang, Hebei (CN); Ling Zhao, Hebei (CN); Lichuan Shen, Hebei (CN); Liling Feng, Hebei (CN)

(21) Appl. No.: 13/576,309

(22) PCT Filed: Sep. 1, 2011
(86) PCT No.: PCT/CN2011/079254

§ 371 Date: Jul. 31, 2012

(30) Foreign Application Priority Data
Sep. 1, 2010 (CN) 201020512087.8

(51) Int. Cl. F02M 31/125

(52) U.S. Cl. CPC F02M 31/125
USPC 123/549

(57) ABSTRACT

An oil-electricity separation type diesel heater comprises an outer shell (2), heating bars (1) and a temperature controller (3). Each of the heating bars (1) includes an electrode piece, a heating piece and an outer covering shell, and is connected to the wiring end of the temperature controller (3) by the electrode piece, and fixedly connected to the outer shell (2) by one end. The temperature controller (3) is arranged inside the outer shell (2), the gaps of the outer shell (2) are filled with a pouring sealant, and a hole (5) is arranged on the outer shell (2) to fix the heater at a mounting position. The heater produced by heating elements can rapidly and evenly be conducted to the diesel so as to reduce the viscosity of the diesel and improve its fluidity, and then optimize the combustion process of the diesel oil. The heater is low-cost, compact in structure, safe and reliable, and convenient for maintenance.

### TECHNICAL FIELD

The present invention relates to a heating device, and in particular to an oil-electricity separation type diesel heater.

### BACKGROUND

With the rapid economic development, many countries around the world are increasingly focusing on energy efficiency issues, and taking corresponding measures. Developing a fuel efficient and environmental diesel engine for vehicles to achieve the goal of energy efficiency in social traffic is important. With the accelerated pace of life, the demand for cars is growing day by day. Many countries are paying high attention to diesel vehicles because of the characteristics of their remarkable fuel efficiency and good environmental performance. It has been proved that the development of modern and advanced diesel engine is by far one of the most effective and economical solution to the problem of the dual pressure of automotive environmental protection and energy-saving. From a global perspective, the dieselization of vehicle engine has become an irreversible trend, and such shortcomings of the diesel fuel at low temperature as increasing viscosity, poor fluidity, bad atomizing, incomplete combustion, and increasing fuel consumption are promoting the development and popularity of diesel fuel heating equipments.

The application of diesel heater overcomes fundamentally the shortcomings above-mentioned of diesel fuel products. The diesel fuel heating equipment heats sufficiently the diesel fuel of low temperature in the automotive fuel supply system, in order to decrease the viscosity of the diesel fuel, improve the fluidity of the diesel fuel, make it easier to filter out the impurities, and facilitate the separation of oil and water, thus optimize the diesel fuel combustion process, reduce fuel consumption, and protect environment.

In a number of diesel fuel heating equipments, the heating is commonly carried out by means of a heating pipe or in a PTC mode, wherein the heating pipe consists of a heating resistance wire and an outer covering pipe, with insulating material filled into the space between the heating resistance wire and the outer covering pipe, and the advantages of this heating pipe are preventing leakage of electricity and warming fast. However, the disadvantage of this heating pipe is the unlimited temperature rising, and it may be dangerous when the temperature is too high. While in the mode of PTC the heating is often carried out by means of an immerging fluid heating, i.e. the electrodes are immerged in the diesel fuel directly, in this case short circuit may happen easily when there is water or conductive impurities.

Chinese Patent application NO. 200620127577.X discloses a heater for diesel engine associated with a filterfor use, the heater includes an outer shell, a heating element of positive temperature coefficient thermistor, an upper heat dissipating electrode piece and a lower heat dissipating electrode piece, both of which are connected tightly to the heating element, and a temperature controller which is connected with the heating element in series, wherein the heating element, the upper heat dissipating electrode piece, the lower heat dissipating electrode piece and the temperature controller are arranged in the outer shell. Patent publication NO. CN 201410334Y discloses an intelligent temperature control heater for diesel fuel filter, which is equipped with a supporting and limiting step and a supporting and limiting post in the outer shell, and the electrode piece and the heating piece are fixed by spring press connecting or screw fastening, and an external electrode post is led out from the electrode piece. The hater is compact in structure, simple structure, convenient for installation and safe for use. Although the heater has high thermal efficiency, it has to be associated with filter for use, and the scope of use and installation of the heater is restricted.

### SUMMARY

A technical problem solved by the present invention is to provide an oil-electricity separation type diesel heater with the advantages of low cost, simple structure, energy saving and environmental friendly, convenient for installation and safe for use.

The above-mentioned technical problems can be solved through the following technical solutions: an oil-electricity separation type diesel heater, the improvement of which is: the oil-electricity separation type diesel heater includes an outer shell, a heating bar and a temperature controller; wherein the heating bar includes an electrode piece, a heating piece and an outer covering shell, and is fixedly connected to the outer shell by one end, the temperature controller is arranged inside the outer shell, the heating bar is connected to the wiring end of the temperature controller by the electrode piece, the gaps of the outer shell are filled with a pouring sealant; and a fixing hole is arranged on the outer shell to fix the oil-electricity separation type diesel heater at a mounting position.

The heating bar includes an electrode piece, a heating piece, an outer covering shell and power supply lead wires led out from the electrode piece, the outer covering shell is a metal outer covering shell, the electrode piece and the heating piece are fixed tightly by a silicon rubber thermal conducting adhesive, they are packed tightly in an imine membrane and arranged into the metal outer covering shell, the gaps of the metal outer covering shell are filled with a high-temperature resistant insulating rubber or magnesium oxide and the opening is sealed with a sealing glue or by welding.

The heating bars includes an electrode piece, a heating piece, an outer covering shell and power supply lead wires led out from the electrode piece; the outer covering shell is an external pressure shell; the heating piece is sandwiched between two electrode pieces, they are packed in an imine membrane and installed into the external pressure shell and pressed tightly by a pressure tester.

The heating piece is a PTC heating piece.

The heating bar is a single one or multiple ones connected in parallel.

The outer shell of the oil-electricity separation type diesel heater further includes a temperature fuse connected with the heating bars and the temperature controller in series.

The advantages of the present invention are: the heater according to the present invention is small in volume, flexible for installation, and may be employed in many different positions to be heated. The shape and structure of the outer shell of the heater and the heating bar may be modified in different ways depending on the installing positions, in order to meet all kinds of heating demands. The electrifying electrode of the heater is connected to the heating piece, and he electrifying electrode of the heater and the heating piece are external insulating treated, and the effect of sealing and heat dissipation are achieved by means of a heat dissipating outer covering shell. There are many methods for insulation may be employed, such as filling insulating material e.g. magnesia, silicon rubber, outer covering insulating membrane and the like, the methods may be varied according to different demands for installation and use. The heating element, temperature controller and the fuse are independent parts, so the heater is simple, convenient and easy to carry out for installation. This invention not only overcomes the disadvantage of unlimited over-high temperature of the resistance wire heating pipe, but also increases the safety and reliability of the heater taking advantages of constant temperature control and non-open fire heating of the PTC thermistor. The heating source includes but not limited to PTC thermistor, and many other heating sources may be employed. The temperature controller may monitor the ambient temperature of the heater automatically, and the heater controlled by the temperature controller will switch on automatically and the heating will begin when the temperature is lower than the switching on temperature of the temperature controller. As the progression of heating the temperature increases continuously, and the heater controlled by the temperature controller will switch off automatically and the heater will stop when the temperature overpasses the switching off temperature of the temperature controller, thereby the intellectual temperature control is achieved, and it is safe and convenient in this way. The temperature fuse plays a role of over-heat protection, and the temperature fuse will be failure and the electric circuit will switch off automatically when the temperature overpasses the burning out temperature of the temperature in the case of continuously heating caused by controller's failure or the overhigh temperature caused by other accidental reasons, thus the dangerous accident of overhigh temperature resulted by continuously heating is prevented.

### BRIEF DESCRIPTION OF THE DRAWINGS

FIG. 1 is a front view of a diesel heater according to an embodiment of the present invention;

FIG. 2 is a left view of a diesel heater according to the embodiment of the present invention;

FIG. 3 is a front view of a diesel heater containing temperature fuse according to the embodiment of the present invention;

FIG. 4 is a bottom view of the diesel heater of FIG. 3;

FIG. 5 is a schematic structural view of a diesel heater containing temperature fuse according to an embodiment of the present invention arranged in a catchment container;

FIG. 6 is a schematic structural view of a diesel heater in another embodiment according to the present invention;

wherein, 1. Heating bar, 2. Outer shell, 3. Temperature controller, 4. Power supply lead wire, 5. Fixing hole, 6. Temperature fuse, 7. Seal ring, 8. Catchment container, 9. Fixing screw.

### DETAILED DESCRIPTION OF THE PREFERRED EMBODIMENTS

Objects, advantages and embodiments of the present invention will be explained below in detail with reference to the accompanying drawings.

### Example 1

An oil-electricity separation type diesel heater, the improvement of which is: the oil-electricity separation type diesel heater includes an outer shell 2, a heating bar 1 and a temperature controller 3. The heating bar 1 includes an electrode piece, a heating piece and an outer covering shell, and is fixedly connected to the outer shell 2 by one end. The temperature controller 3 is arranged inside the outer shell 2. The heating bar 1 is connected to the wiring end of the temperature controller 3 by the electrode piece. The gaps of the outer shell 2 are filled with a pouring sealant; and a fixing hole 5 is arranged on the outer shell 2 to fix the oil-electricity separation type diesel heater at a mounting position.

The heating bar 1 includes an electrode piece, a heating piece, an outer covering shell and some power supply lead wires. The outer covering shell is a metal outer covering shell. The side of the electrode piece clung to the heating piece is coarsened by a sand paper to facilitate the connection of the heating piece with the electrode piece. After the electrode piece is cleaned with an alcohol, the coarsened side of the electrode piece is coated with a silicon rubber thermal conducting adhesive and the heating piece is put onto the side coated with the silicon rubber thermal conducting adhesive, thereafter the heating piece and the electrode piece are bound together tightly by means of drying at high temperature after they are fixed, thereby achieving the electrical connection of the basic electric circuit. The heating piece and the electrode piece are packed tightly within an imine membrane, the power supply lead wires 4 are led out from the electrode piece, and a first insulating protecting layer of the electrode is formed by means of the insulation of the imine membrane. The heating piece and the electrode piece packed in the imine membrane are arranged into a metal outer covering shell, and the gaps of the metal outer covering shell are filled with a high temperature resistant insulating rubber or a magnesium oxide powder, as a result, the transfer of the heat from the heating piece is improved on the one hand and a second insulating protecting layer of the electrode is formed on the other hand. At last, the opening is sealed with a sealing glue or by welding, thus ensure that the heating bar 1 will not leak electricity.

One or more qualified installed heating bar(s) is(are) connected in parallel, and are welded with a temperature controller 3 and a temperature fuse 6 according to an electric circuit requirement, and they are fixed on the outer shell 2 before each of the elements and the exposed part of the electric circuit are sealed and fixed with a pouring sealant or by other methods. Whether the temperature fuse 6 would be used or not depends on the temperature of the heating bar 1, the temperature fuse 6 may not be used when the heating temperature of the heating bar 1 is as low as not to exceed the safe temperature of the substance to be heated, otherwise the temperature fuse 6 may be installed to carry out over-heating protection.

The temperature controller 3 is an automatic temperature control type temperature controller, i.e. the temperature controller 3 will switch on automatically, and the heating bar 1 will begin to heat the diesel fuel(or other medium to be heated) to make its temperature and its fluidity continuously increased when the diesel fuel temperature is lower than the setting temperature of the temperature controller 3, whereas the temperature controller 3 will switch off automatically and the heater will stop heating when the temperature of the diesel fuel reaches to the setting switching off temperature of the temperature controller 3. When the temperature controller 3 fails, the temperature will be controlled by the temperature fuse 6. There is a certain temperature difference between the temperatures controlled by the temperature fuse 6 and the temperature controller 3, and the temperature fuse 6 will burn out and the electric circuit will be cut off by force when the temperature controller 3 fails and the temperature of the diesel fuel exceeds the setting temperature of the temperature controller 3 and reaches the setting temperature of the temperature fuse 6, thereby ensuring the safety of the engine.

### Example 2

The heating bar 1 of Example 1 is improved as follows: the outer covering shell is an external pressure shell, and the heating piece of the heating bar 1 is sandwiched between two electrode pieces, packed in an imine membrane and they are arranged as a whole into the external pressure shell, thereafter they are pressed to the desired height by a pressure tester. The basic electric circuit connection of the electrode piece and the heating piece is achieved by the pressure of the external pressure shell, and the qualified pressed heating bar 1 is tested with multimeter to ensure that there is no short circuit in the electrode piece and the heating piece after they are connected with pressure, and the resistance value of the heating piece is qualified.

In the process of the manufacture of the heating bar, the outer shell of the heating bar may be used as the negative electrode of the heating piece in the implement process, i.e. the cathode electrode may be taken out during the installation of the heating piece and the electrode piece, meanwhile the outer shell of the heating bar acts as the cathode electrode of the heating piece directly and the anode electrode piece is insulated from the outer shell. Alternatively, the cathode and anode electrode pieces and the heating piece are arranged into the heating outer shell at the same time, but only the anode electrode is insulated from the outer shell, and the cathode electrode is clung to the heating outer shell tightly.

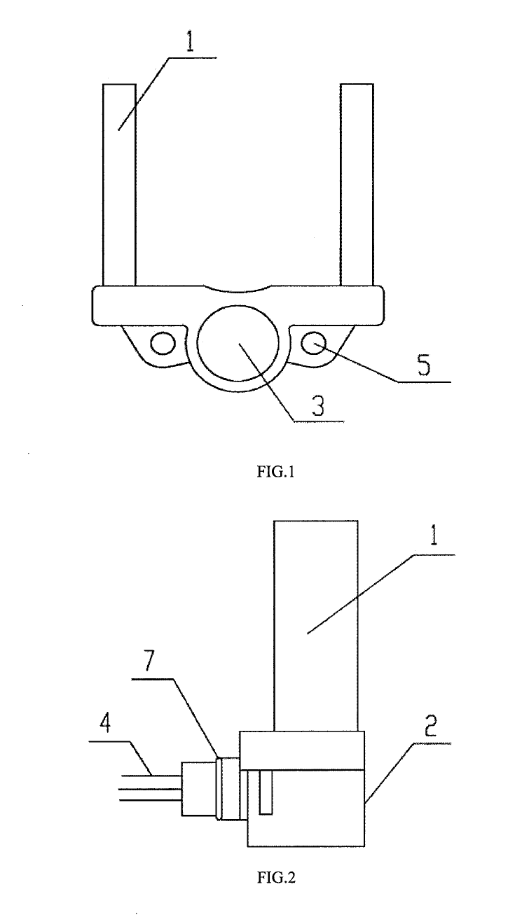

The oil-electricity separation type diesel heater according to the present invention is flexible for installation, and may be used in many different positions to be heated. The shape and structure of the outer shell 2 of the heater and the heating bar 1 may be modified in many ways depending on different installing position, in order to meet all kinds of heating requirements. Considering the limited space of the catchment container of the heater, as shown in FIG. 1 and FIG. 2, the heating bar 1 is arranged in the outer shell 2 transversely, and two heating bars 1 are connected in parallel before connected with the temperature controller 3 in series, and the power supply lead wires 4 are led out of the outer shell 2, at last they are encapsulated and fixed with epoxy resin adhesive.

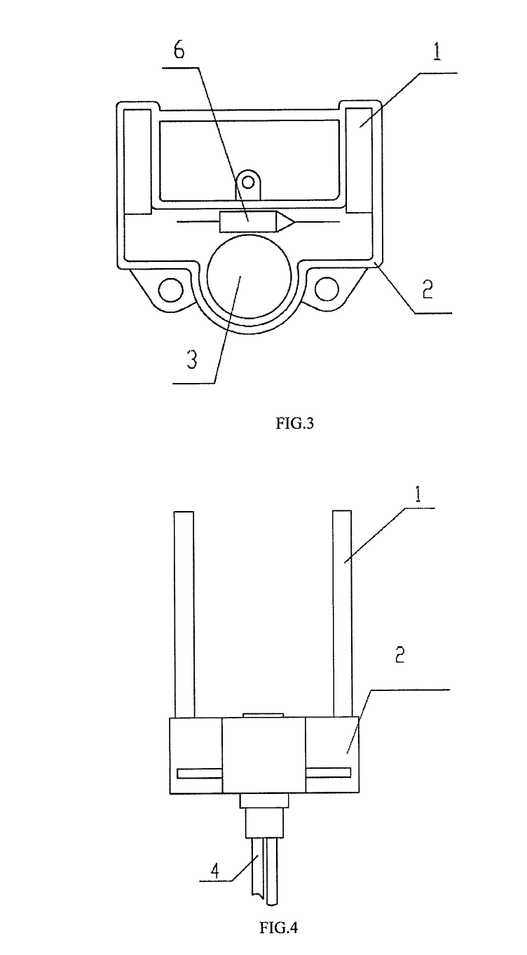

As shown in FIG. 3 and FIG. 4, the heating bars 1 of the heater of this structure are connected in parallel before they are arranged in the outer shell 2 vertically. The heating bars 1 are connected with the temperature controller 3 and temperature fuse 6 in series, and they are arranged in the outer shell 2, the power supply lead wires 4 are led out of the outer shell 2, at last they are encapsulated and fixed with epoxy resin adhesive.

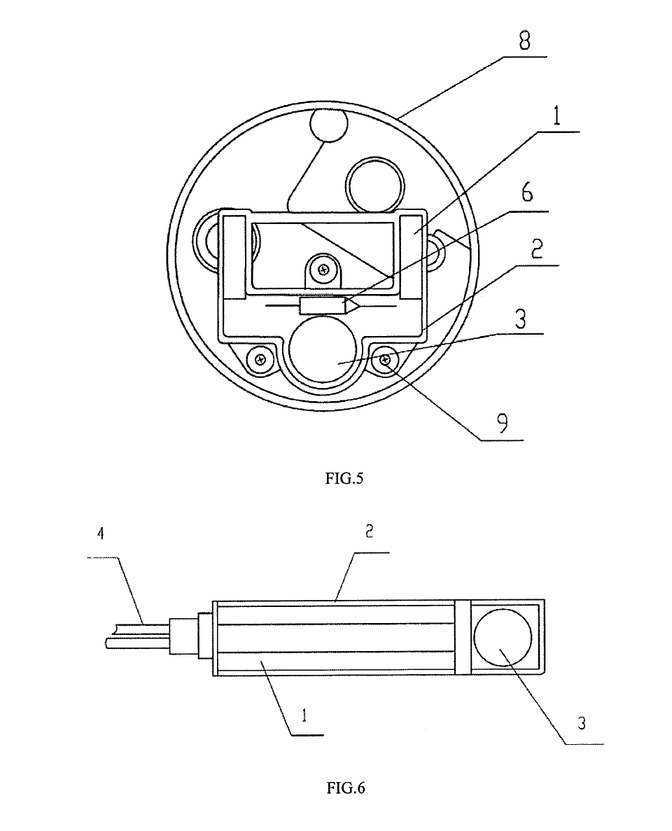

The heaters with the two structures above-mentioned can be arranged in the catchment container(also called sediment bowl) of the oil-water separator, and the mode of installation is shown in FIG. 5. The heater is fixed on the catchment container 8 through the fixing screws 9 and the fixing holes 5 on the outer shell of the heater, and the power supply lead wires 4 are led out of the catchment container through the mounting hole of the heater at the bottom of the catchment container. The power supply lead wires 4 may be protected by the covering tube, with a connector installed on the end of the power supply lead wires 4 so as to connect to a vehicle working power. The connecting gaps between the heater and the catchment container may be sealed with a seal ring 7, alternatively, they may be encapsulated and sealed with epoxy resin adhesive, thereby increasing the reliability.

As shown in FIG. 6, the integral heating bar 1 may be arranged in the outer shell 2 transversely. One end of the heating bar 1 is connected to the temperature controller 3 and power supply lead wires 4 are led out from the other end of the heating bar 1. The heater may be installed in a fuel tank or an oil tank, and be fixed in the proper position to be heated by an external connecting line. The shape of the heater may be changed in order to carry out the installation on top or on side in the position to be heated, i.e. the heater may extend to the position to be heated from the outside (top or side) of the container to be heated, and it is fixed on the outer wall of the container through the fixing holes on the body of the outer shell.

What is claimed is:

1. An oil-electricity separation type diesel heater comprising:
an outer shell (2), a heating bar (1) and a temperature controller (3); wherein the heating bar (1) comprises an electrode piece, a heating piece and an outer covering shell, and is fixedly connected to the outer shell (2) by one end;
the temperature controller (3) is arranged inside the outer shell (2); the heating bar (1) is connected to the wiring end of the temperature controller (3) by the electrode piece; the gaps of the outer shell (2) are filled with a pouring sealant;
and a fixing hole (5) is arranged on the outer shell (2) to fix the oil-electricity separation type diesel heater at a mounting position.

2. The oil-electricity separation type diesel heater as claimed in claim 1, wherein the heating bar (1) comprises an electrode piece, a heating piece, an outer covering shell and power supply lead wires led out from the electrode piece; the outer covering shell is a metal outer covering shell, the electrode piece and the heating piece are fixed tightly by a silicon rubber thermal conducting adhesive, they are packed tightly in an imine membrane and arranged into the metal outer covering shell, the gaps of the metal outer covering shell are filled with a high-temperature resistant insulating rubber or magnesium oxide and the opening is sealed with a sealing glue or by welding.

3. The oil-electricity separation type diesel heater as claimed in claim 1, wherein the heating bar (1) comprises an electrode piece, a heating piece, an outer covering shell and power supply lead wires led out from the electrode piece; the outer covering shell is an external pressure shell; the heating piece is sandwiched between two electrode pieces, they are packed in an imine membrane and installed into the external pressure shell and pressed tightly by a pressure tester.

4. The oil-electricity separation type diesel heater as claimed in claim 3, wherein the heating piece is a PTC heating piece.

5. The oil-electricity separation type diesel heater as claimed in claim 4, wherein the heating bar(1) is a single one or multiple ones connected in parallel.

6. The oil-electricity separation type diesel heater as claimed in claim 5, wherein the outer shell (2) of the oil-electricity separation type diesel heater further comprises a temperature fuse(6) connected with the heating bar (1) and the temperature controller (3) in series.
